(19) United States
(12) Patent Application Publication
(10) Pub. No.: US 2007/0247736 A1
(43) Pub. Date: Oct. 25, 2007

(54) Disk drive apparatus and method for writing and/or reading user data thereof

(75) Inventors: Fuminori Sai, Kanagawa (JP); Kohji Takasaki, Kanagawa (JP); Yutaka Ozawa, Kanagawa (JP); Naoki Tajima, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/788,524

(22) Filed: Apr. 19, 2007

(30) Foreign Application Priority Data
Apr. 19, 2006 (JP) 2006-115306

(51) Int. Cl. G11B 5/09

(52) U.S. Cl. 360/51

(57) ABSTRACT

Embodiments in accordance with the present invention suppress an adverse influence on a pattern of a magnetic disk due to its rotational jitter and write the pattern at more accurate timing. In accordance with one embodiment, a hard disk controller/microprocessing unit (HDC/MPU) controls a clock frequency of a data clock generation circuit so that a rotational jitter of the magnetic disk be compensated when writing and reading user data. The HDC/MPU expects a detection timing of next adjacent servo sector using an error between an actual detection timing and an expected detection timing of a servo sector which has already been detected. The HDC/MPU controls the clock frequency using the expected timing and writes and reads user data between current servo sector and next adjacent servo sector according to the clock signal.

### CROSS-REFERENCE TO RELATED APPLICATION

The instant nonprovisional patent application claims priority to Japanese Patent Application No. 2006-115306 filed Apr. 19, 2006 and incorporated by reference in its entirety herein for all purposes.

### BACKGROUND OF THE INVENTION

Data storage devices using various types of media such as optical discs and magnetic tapes are known. Among them, hard disk drives (hereinafter referred to as HDDs) have become popular as storage devices for computers to such an extent that they are one of the storage devices indispensable for today's computers. Further, not limited to computer systems, the excellent characteristics of HDDs have been expanding their applications into the areas of moving picture recording/reproducing devices, car navigation systems, cellular phones, and removable memories for use in digital cameras.

FIG. 7 schematically shows write data conditions on a recording surface of a magnetic disk 11. As shown in FIG. 7, a plurality of servo areas 111 and data areas 112 each provided between adjacent two of the plurality of the servo areas 111 are formed on the recording surface of the magnetic disk 11. The plurality of servo areas 111 are formed at predetermined angular intervals and extend from the center of the magnetic disk 11 in the radial direction. In this specification, each servo area 111 is referred to as a servo sector. FIG. 7 shows an example of 12 servo sectors.

A servo sector 111 and a data area 112 are alternately formed at predetermined angular intervals. Servo data is written in each servo sector 111 to perform positioning control of a head element section 12, and user data is written in each data area 112.

A plurality of data tracks 113 are concentrically formed on the recording surface of the magnetic disk 11 and have a predetermined width in the radial direction. User data is written along the data tracks 113. Each data area 112 and each data track 13 are addressed based on servo data in each servo sector.

In each data track 113, user data is written on a data sector basis. Further, the data tracks 113 are grouped into a plurality of zones 114a to 114c based on the radial positions on the magnetic disk 11. The number of sectors included in a single data track 113 is set for each zone, and a recording frequency of user data is also set for each zone.

The magnetic disk 11 is rotated by a spindle motor (SPM) mounted in a HDD. Although the magnetic disk 11 is fixed to a spindle of the SPM, the magnetic disk 11 may be shifted with respect to the spindle of the SPM due to a shock from outside or the like. If such a disk shift occurs, the head motion is fluctuated more largely than the usual when the head is following to data track. This point is disclosed, for example, in Japanese Patent Laid-open No. 2006-12350.

A problem of disk shift will be described in detail hereunder. Under normal conditions, a rotational center R0 of the magnetic disk 11 coincides with a track circle center T0 of a data track, as shown in FIG. 8(a). At a radial position r, a time interval from a servo sector SRV[0] to a servo sector SRV[1] is the same as a time interval from the servo sector SRV[N/2] to the servo sector SRV[N/2+1] on the opposite side.

Then, as shown in FIG. 8(b), suppose that the magnetic disk 11 shifts by a distance “s” from the servo sector SRV[0] side toward the servo sector SRV[N/2] side. In terms of each radial position r of the servo sectors SRV[N/2] and SRV[0] under normal conditions, a rotational radius of the servo sector SRV[N/2] is (r+s) and that of the servo sector SRV[0] is (r−s). In this case, the time interval during which the head element section moves through a data area DA[0] and the time interval during which it moves through the data area DA[N/2] are Ts*r/(r+s) and Ts*r/(r−s), respectively. The time intervals are different from each other. Ts is a time interval during which the head element section moves through each data area before disk shift, and is basically constant.

FIG. 9(a) shows a condition in which user data is written into the data areas DA[0] and DA[1] under normal conditions. On the other hand, FIG. 9(b) shows a condition in which user data is written into the data areas DA[0] and DA[1] under disk shift conditions. The data area DA[0] in FIG. 9(b) is r/(r+s) times the data area DA[0] in FIG. 9(a).

As shown in FIG. 9(a), three data sectors SCT[0] to SCT[2] and one part of a split sector, SCT[3a], are written into the data area DA[0]; and the other part of the split sector, SCT[3b], and three data sectors SCT[4] to SCT[6] are written into the data area DA[1]. The split sector SCT[3] is split by the servo sector SRV[1].

In both cases where the disk is shifted and where there it is not shifted, user data is written according to the same clock signal. Therefore, the length of each data sector remains unchanged regardless of whether the disk is shifted or not. Since writing to the data area DA[0], i.e., writing of data sector SCT[0] starts after a preset number of clocks from the detection time of the servo sector SRV[0], there is no problem as shown in FIG. 9(b).

However, since the servo sector SRV[1] comes early at the end portion of the data area DA[0], the end portion of a part of the split sector, SCT[3b], overlaps with the servo sector SRV[1]. In this manner, it would be likely that the data to be stored does not fit into a specified design data area. To avoid this, it is necessary to have a sufficient buffer area between data sectors or between data in a data area and a servo sector as a gap. On the other hand, user data is not written onto the end of the data area DA[N/2] and a large unused area exists therein. Such disk shift produces large variations of the intervals between servo sectors, which may reach about 0.5%.

On the other hand, the following describes a case when data written onto the magnetic disk 11 under normal conditions is read under disk shift conditions with reference to FIG. 10(a) and FIG. 10(b). FIG. 10(a) shows data written onto the magnetic disk 11 under normal conditions. FIG. 10(b) shows a case when data written onto the magnetic disk 11 under normal conditions is read under disk shift conditions.

When disk shift shown in FIG. 8 occurs, the time interval between the servo sectors SRV[0], SRV[1], and SRV[2] decreases, as shown in FIG. 10(b). Specifically, the data area DA[0] and each data sector therein are temporally compressed by r/(r+s). To read these data sectors correctly, it is necessary to use a frequency which is (r+s)/r times the clock frequency under normal conditions as a clock frequency for read operation.

The same phenomenon is caused also by a rotational jitter of the SPM, in addition to disk shift. The rotating speed of the SPM and magnetic disk fluctuates (the fluctuation is referred to as a rotational jitter). A rotational jitter of the SPM is normally about 0.1% or less. For example, in the case of 4200 rpm and 168 servo sectors, the interval between servo sectors is 85 μs and therefore 0.1% of the interval is 85 ns. This means that a 85-ns jitter exists between servo sectors. It is necessary to absorb this jitter by means of a gap between data sectors or between a data sector and a servo sector, as mentioned above.

As is understandable from these examples, a larger gap between data sectors is necessary for the phenomenon which produces a difference between the frequency of user data on the recording surface and the clock frequency in signal processing used for actual read/write operation, such as a rotational jitter of the SPM or disk shift. Further, in the worse case, it would be likely that user data is written onto a servo area or user data cannot be read correctly.

### BRIEF SUMMARY OF THE INVENTION

Embodiments in accordance with the present invention suppress an adverse influence on a pattern of a magnetic disk due to its rotational jitter and write the pattern at more accurate timing. In the particular embodiment of the present invention shown in FIG. 3, a hard disk controller/microprocessing unit (HDC/MPU) 23 controls a clock frequency of a data clock generation circuit 212 so that a rotational jitter of the magnetic disk be compensated when writing and reading user data. The HDC/MPU 23 expects a detection timing of next adjacent servo sector using an error between an actual detection timing and an expected detection timing of a servo sector which has already been detected. The HDC/MPU 23 controls the clock frequency using the expected timing and writes and reads user data between current servo sector and next adjacent servo sector according to the clock signal.

### BRIEF DESCRIPTION OF THE DRAWINGS

FIG. 1 is a block diagram schematically showing a general configuration of a hard disk drive according to an embodiment of the present invention.

FIG. 2 is a diagram schematically showing a data format of a servo sector according to an embodiment of the present invention.

FIG. 3 is a block diagram schematically showing a logical configuration relevant to control of a data clock frequency according to an embodiment of the present invention.

FIG. 4 is a diagram schematically showing a time interval when there is no rotational jitter of a magnetic disk and a time interval when there is a rotational jitter of a magnetic disk, with respect to three consecutive servo sectors according to an embodiment of the present invention.

FIG. 5 is a diagram showing a result of simulation of clock frequency control by PID control according to an embodiment of the present invention.

FIG. 6 is a diagram showing a result of simulation of clock frequency control using a measured detection interval of each servo sector according to an embodiment of the present invention.

FIG. 7 is a diagram schematically showing a condition of write data on a recording surface of a magnetic disk according to background arts.

FIG. 8 is a diagram schematically showing a change of an interval between servo sectors by disk shift according to background arts.

FIG. 9 is a diagram schematically showing a change of a write position of user data by disk shift according to background arts.

FIG. 10 is a diagram schematically showing a relationship between disk shift and data sector in a read process according to background arts.

### DETAILED DESCRIPTION OF THE INVENTION

Embodiments in accordance with he present invention relate to a disk drive apparatus and a method for writing and/or reading user data thereof. More particularly, the present invention relates to clock frequency control according to a timing of detecting a servo sector.

An aspect of embodiments in accordance with the present invention is a method for writing and/or reading user data on a rotating recording surface having a plurality of servo sectors separately arranged in the circumferential direction and a plurality of data areas for user data storage between the plurality of servo sectors. This method comprises the steps of estimating a detection timing of the next adjacent servo sector using a difference between an actual detection timing and an expected detection timing of a servo sector that has been already detected; controlling a clock frequency according to the detection timing of the next expected servo sector; and writing and/or reading user data between current servo sector and the next adjacent servo sector according to a clock signal having the above-mentioned controlled frequency. This makes it possible to easily and effectively perform clock control and write and/or read user data according to a rotational jitter on the recording surface.

To ensure easy stable control, the detection timing of the next adjacent servo sector may be expected using an integral term of a difference between an actual detection timing and an expected detection timing of plural servo sectors which have already been detected. Further, the detection timing of the next adjacent servo sector may be expected using an integral term of a difference between an actual detection timing and an expected detection timing of plural servo sectors which have already been detected and a difference term between the actual detection timing and expected detection timing of the current servo sector. Further, the detection timing of the next adjacent servo sector may be expected using an integral term of a difference between an actual detection timing and an expected detection timing of plural servo sectors which have already been detected, a difference term between the actual detection timing and the expected detection timing of the current servo sector, and a differential term of the difference between the actual detection timing and the expected detection timing of the current servo sector, and a difference between an actual detection timing and an expected detection timing of immediately previous servo sector which has been detected.

Whether user data can be written or not may be determined based on the above-mentioned expected detection timing. This makes it possible to prevent user data from being written onto a wrong position when a rotational jitter component is large.

A disk drive apparatus concerning another aspect of the present invention comprises: a motor which rotates a disk having a plurality of servo sectors separately arranged in the circumferential direction and a plurality of data areas for user data storage between the plurality of servo sectors; a controller which expects a detection timing of next adjacent servo sector using a difference between an actual detection timing and an expected detection timing of a servo sector which has already been detected; a clock generation circuit which generates a clock signal having a frequency controlled according to the detection timing of the next expected servo sector; and a head which writes and/or reads user data between current servo sector and the next adjacent servo sector according to a clock signal having the above-mentioned controlled frequency. This makes it possible to easily and effectively perform clock control and write and/or read user data according to a rotational jitter on the recording surface.

To ensure easy and stable control, the above-mentioned controller may expect a detection timing of the next adjacent servo sector using an integral term of a difference between an actual detection timing and an expected detection timing of plural servo sectors which have already been detected. Further, the above-mentioned controller may expect a detection timing of the next adjacent servo sector using an integral term of a difference between an actual detection timing and an expected detection timing of plural servo sectors which have already been detected and a difference term between the actual detection timing and expected detection timing of the current servo sector. The above-mentioned controller may control the above-mentioned clock frequency based on PID control using a difference between a actual detection timing and an expected detection timing of a servo sector which has already been detected.

A disk drive apparatus may further comprises a fixed clock generation circuit which generates a clock signal having a fixed frequency, wherein the above-mentioned controller measures a detection timing of each servo sector by use of the clock signal having the above-mentioned fixed frequency. This makes it possible to effectively perform clock control on a small circuit scale.

A disk drive apparatus concerning still another aspect of the present invention comprises: a motor which rotates a disk having a plurality of servo sectors separately arranged in the circumferential direction and a plurality of data areas for user data storage between the plurality of servo sectors; a controller which determines a clock frequency using a multiply-and-accumulation value of detection intervals between servo sectors which have already been detected, the detection intervals being multiplied by a weighting factor that is set so that it becomes smaller for more past data; a clock generation circuit which generates a clock signal having the above-mentioned determined click frequency; and a head which writes and/or reads user data between current servo sector and the next adjacent servo sector according to the clock signal from the above-mentioned clock generator circuit. This makes it possible to easily and effectively perform clock control and write and/or read user data according to a rotational jitter on the recording surface.

The above-mentioned controller may calculate a value obtained by multiplying the multiply-and-accumulation value used to determine a clock frequency in immediately previous servo sector by a predetermined coefficient, and determines the above-mentioned clock frequency using a sum of the detection interval between current servo sector and the immediately previous servo sector, and the above-mentioned calculated value. This makes calculations easier. Further, it is preferable that the predetermined coefficient be a positive value less than one.

In accordance with embodiments of the present invention, it is possible to write and/or read user data at more accurate timing.

An embodiment of the present invention will be described hereunder using an example of a hard disk drive (HDD), a type of disk drive apparatus, with reference to the accompanying drawings. In order to clarify explanations, the following descriptions and drawings are omitted or simplified as required and, in each drawing, the same symbols are assigned to the same elements and duplicated explanations are omitted as required.

A HDD according to an embodiment controls a clock frequency so that a rotational jitter of a magnetic disk be compensated when writing and/or reading user data. The HDD expects a detection timing of next adjacent servo sector using an error between an actual detection timing and an expected detection timing of a servo sector which has already been detected. The clock frequency is controlled by use of the expected timing, and user data between current servo sector and next adjacent servo sector is written and/or read according to the clock signal.

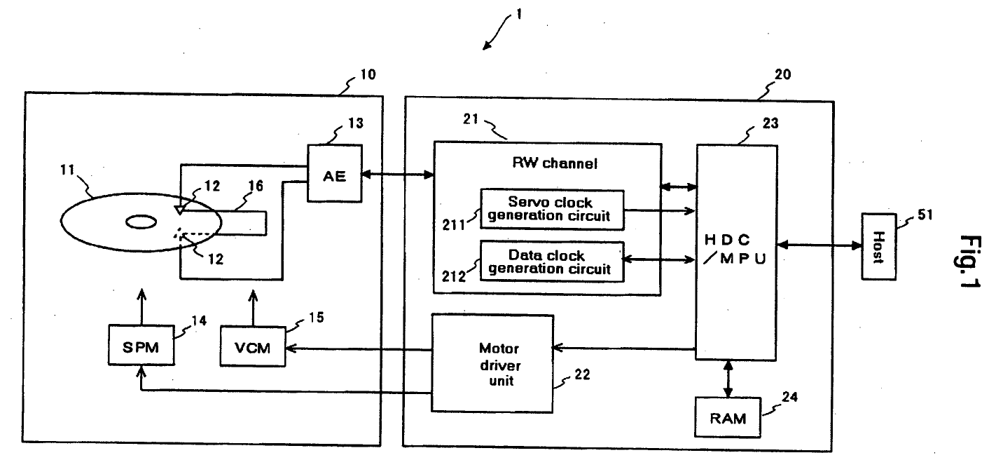

To make it easier to understand features of the present embodiment, a general configuration of the HDD will be described first. FIG. 1 is a block diagram schematically showing a general configuration of a HDD 1. The HDD 1 includes a magnetic disk 11, a type of disk for data storage; head element sections 12, a type of head; an arm electronic circuit (arm electronics or AE) 13; a spindle motor (SPM) 14; a voice coil motor (VCM) 15; and an actuator 16, in an enclosure 10.

The HDD 1 further includes a circuit board 20 fixed to the outside of the enclosure 10. On the circuit board 20, installed are a read/write channel (R/W channel) 21, a motor driver unit 22, a hard disk controller (HDC), and a hard disk controller (HDC)/microprocessing unit (MPU) integrated circuit (hereinafter referred to as HDC/MPU) 23, and other ICs such as a RAM 24. Circuit components can be integrated in a single IC or implemented in a plurality of ICs.

User data from an external host 51 is received by the HDC/MPU 23 and then written onto the magnetic disk 11 by the head element sections 12 through the R/W channel 21 and AE 13. Further, user data stored on the magnetic disk 11 is read by the head element sections 12 and then outputted from the HDC/MPU 23 to the external host 51 through the AE 13 and R/W channel 21.

The magnetic disk 11 is fixed to the SPM 14. The SPM 14 rotates the magnetic disk 11 at a predetermined angular speed. The motor driver unit 22 drives the SPM 14 in accordance with control data from the HDC/MPU 23. The magnetic disk 11 of this example is provided with data recording surfaces on both sides, and the head element sections 12 corresponding to each recording surface are implemented.

Each head element section 12 is fixed to a slider (not shown) which is fixed to the actuator 16. The actuator 16, connected to a VCM15, rotates around a rotating shaft to move the head element sections 12 (and the slider) in the radial direction on the magnetic disk 11. The motor driver unit 22 drives the VCM 15 according to control data from the HDC/MPU 23. The head element sections 12 include a writing element which converts an electrical signal into a magnetic field according to write data to the magnetic disk 11, and a reading element which reconverts the magnetic field from the magnetic disk 11 into the electrical signal. The number of magnetic disks 11 may be one or more, and a recording surface may be formed on one side or both sides of the magnetic disk 11.

The AE 13 selects one of the head element sections 12 that performs data access, amplifies with a fixed gain a read signal reproduced by the selected head element section 12, and transmits the signal to the R/W channel 21. Further, the AE 13 transmits a record signal from the R/W channel to the selected head element section 12.

In the write process, the R/W channel 21 performs code modulation of the data supplied from the HDC/MPU 23, converts the code-modulated data into a write signal, then supplies the write signal to the AE 13. Further, in the read process, the R/W channel 21 amplifies the read signal supplied from the AE 13 to obtain a constant amplitude, extracts the read data from the acquired read signal, then performs decode processing. The decoded data is then transferred to the HDC/MPU 23. The R/W channel 21 includes a servo clock generation circuit 211 and a data clock generation circuit 212. Further, the R/W channel 21 of the present embodiment controls (performs frequency modulation of) the clock frequency of the data clock generation circuit 212 in response to a request from the HDC/MPU 23. Each of the clock generation circuits 211 and 212 will be described later herein.

The MPU in the HDC/MPU 23, a type of controller, operates according to microcodes that have been loaded into the RAM 24. As the HDD 1 starts operating, the data required for control and data processing, as well as the microcodes that operate in the MPU, is loaded from the magnetic disk 11 or a ROM (not shown) into the RAM 24. The HDC/MPU 23 performs general control of the HDD 1, in addition to necessary data processing such as interface control and servo-data-based positioning control of the head element sections 12. Clock control for reading and writing of the user data of the present embodiment is performed by the HDC/MPU 23. This point will be described later herein.

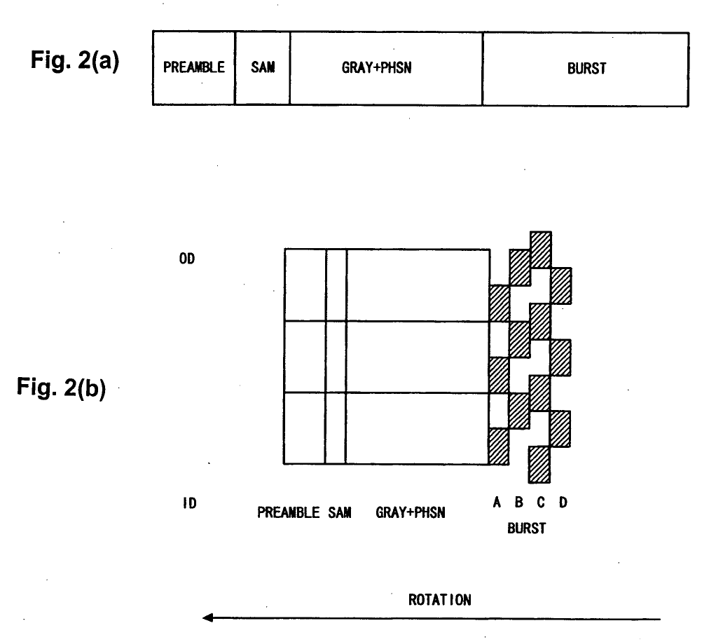

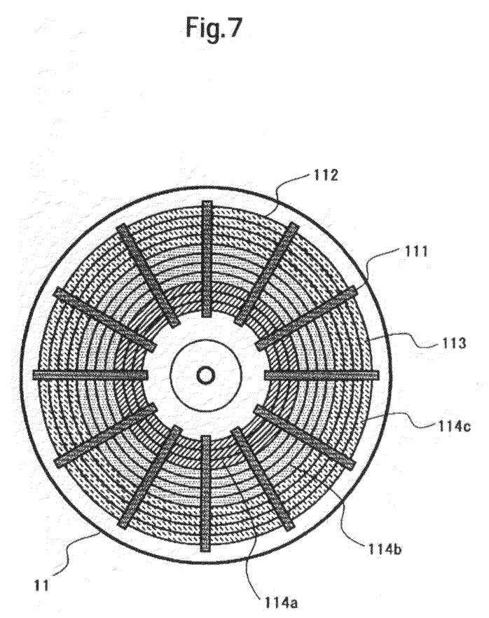

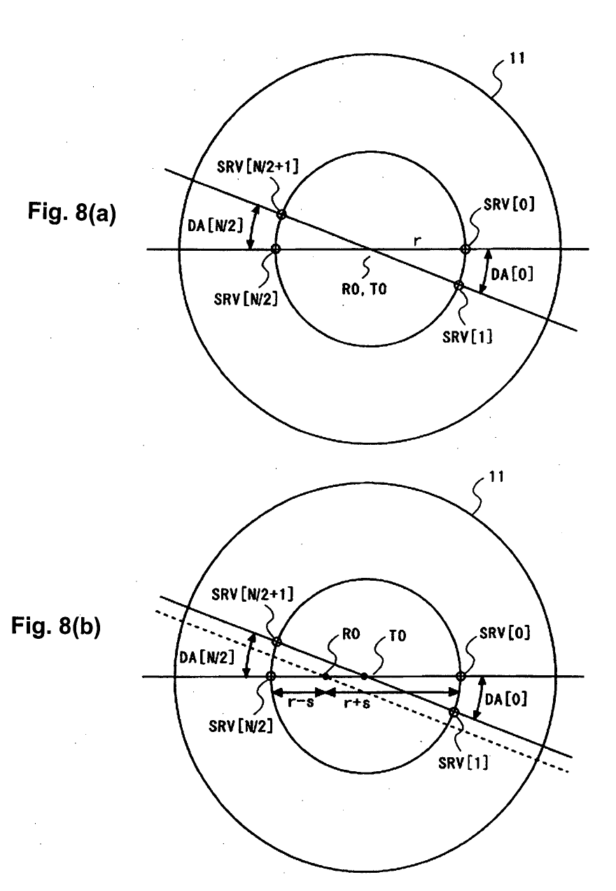

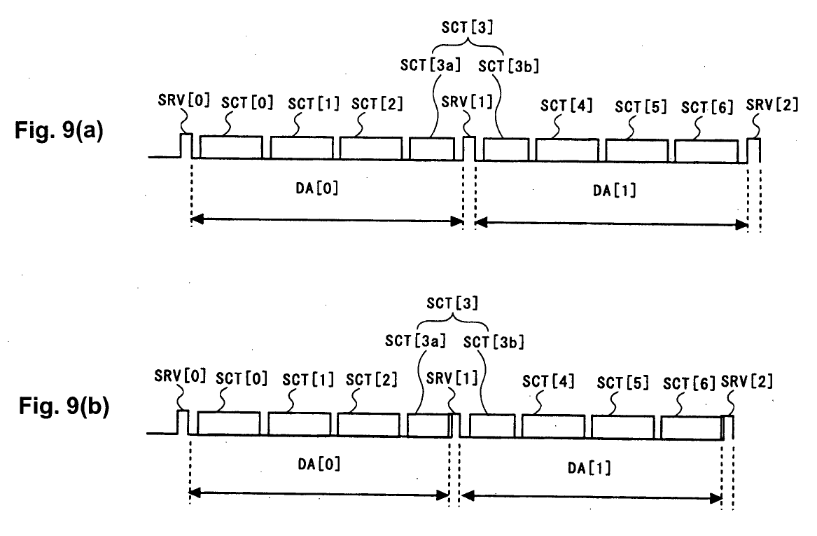

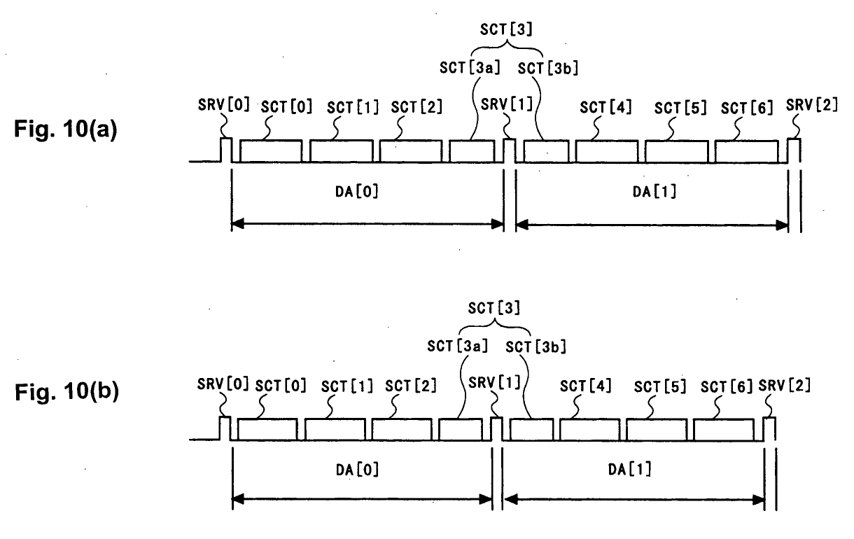

As explained with reference to FIG. 7, the recording surface of the magnetic disk 11 has a plurality of servo sectors 111 separately arranged in the circumferential direction and a plurality of data areas 112 between two adjacent servo sectors 111. FIG. 2(a) shows a unit of servo pattern format, which is a pattern for a single servo track in a single servo sector. A servo pattern includes a preamble (PREAMBLE), a servo address mark (SAM), a servo tracks ID (GRAY) consisting of a gray code, a servo sector number (PHYS), and a burst pattern (BURST).

The preamble is a repetitive pattern at a certain frequency used for synchronization. The R/W channel 21 controls the servo clock generation circuit 211 for synchronization with a preamble signal read from the magnetic disk 11. Further, the R/W channel 21 controls the gain of a variable gain amplifier (not shown) to adjust the output with a specified value. The SAM is a portion which indicates the start of actual information, such as a servo track ID. The HDC/MPU 23 controls reading and writing of user data with reference to detection of the SAM.

The servo track ID indicates a position and sequence of a servo sector in the radial direction, and the servo sector number indicates a sequence of a servo sector in the circumferential direction. The burst pattern (BURST) is a signal which indicates a more precise position of a track indicated by the servo track ID. In this example, the burst pattern includes four different amplitude signals (A, B, C, and D) that are written in a zigzag fashion at slightly different circumferential positions along each servo track. Each of these bursts is a single-frequency signal having the same period as the preamble (PREAMBLE).

FIG. 2(b) shows a part of a servo sector. Each servo sector has servo data of a plurality of servo tracks arranged in the radial direction. FIG. 2(b) shows an example of three servo tracks. Two different formats are known. In one format, servo tracks and data tracks have the same track pitch; in the other format, they have different track pitches. Embodiments in accordance with the present invention may be applied to a magnetic disk with either one of the two formats.

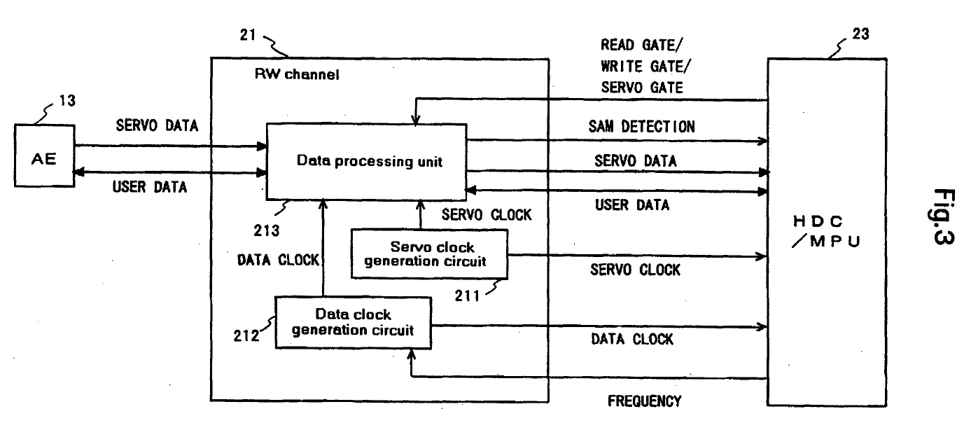

With reference to detection of a SAM of a servo sector, the HDC/MPU 23 reads and writes user data between the servo sector and next adjacent servo sector. Specifically, as shown in FIG. 3, a data processing unit 213 in the R/W channel 21 performs read operation of a servo sector by use of a clock signal (SERVO CLOCK) of the servo clock generation circuit 211 according to a control signal (SERVO GATE) from the HDC/MPU 23. When the data processing unit 213 detects the SAM of the servo sector, it notifies the HDC/MPU 23 of the detection (SAM DETECTION).

In the write process, the HDC/MPU 23, after receiving SAM DETECTION, starts counting the clock signal (DATA CLOCK) of the data clock generation circuit 212 to measure time. When a predetermined number has been counted, the HDC/MPU 23 asserts a control signal (WRITE GATE) to give an instruction for writing user data to the data processing unit 213. The data processing unit 213 then processes the user data according to the clock signal (DATA CLOCK) of the data clock generation circuit 212 and transfers it to the AE 13.

Likewise in the read process, the HDC/MPU 23, after receiving SAM DETECTION from the data processing unit 213, starts counting the clock signal (DATA CLOCK) of the data clock generation circuit 212 to measure time. When a predetermined number has been counted, the HDC/MPU 23 asserts a control signal (READ GATE) to give an instruction for reading user data to the data processing unit 213. The data processing unit 213 then processes the read user data according to the clock signal (DATA CLOCK) of the data clock generation circuit 212 and transfers it to the HDC/MPU 23.

If a rotational jitter of SPM 14 or disk shift causes a large difference between the frequency of the user data on the recording surface and the frequency of the data clock generation circuit 212 which is a signal processing clock used for actual read/write operation, it would be likely that user data is written onto a servo area or user data cannot be read correctly. Further, a large gap is required as a buffer area between data sectors or between a data sector and a servo sector so that the difference be absorbed.

The HDC/MPU 23 of the present embodiment controls the frequency of the data clock generation circuit 212 so that time expansion or reduction of a data area between servo sectors by a rotational jitter of the SPM 14 or disk shift be compensated. This makes it possible to prevent write/read errors of user data and reduce buffer areas required in data areas, resulting in an increase in the storage capacity of the magnetic disk 11.

In order to control the frequency of the data clock generation circuit 212, the HDD 1 of the present embodiment measures a length of each data area (interval between servo sectors), calculates how much the measured value has shifted from a specified design value, and controls the frequency of the data clock generation circuit 212 so that the shift be compensated. For this reason, the HDC/MPU 23 measures a detection timing of a SAM in each servo sector and uses a time difference of a SAM detection timing between consecutive servo sectors as a time length for the corresponding data area. It would be possible that measurement of a SAM detection timing is performed by the R/W channel 21 and the results be transferred to the HDC/MPU 23.

SAM detection time of a servo sector [i] is denoted as Ts[i], where i is a suffix which indicates the servo sector number. Further, Ds[i] indicates a time interval between SAM detection timings in adjacent servo sectors [i] and [i+1] in the circumferential direction.

Therefore, Ds[I] is expressed as following:

Ds[i]=(Ts[i+1]−Ts[i]) Expression (1)

Before disk shift occurs, SAM detection time of the servo sector [i] during normal rotation is denoted as Ts0[i]. Further, a time interval between SAM detection timings in the servo sectors [i] and [i+1] is denoted as Ds0[i]. Ideally, Ds0[i] is constant for all servo sectors in a single circumference on the magnetic disk 11. Ds0[i] is measured in the manufacturing process before shipment of the HDD 1. Specifically, the R/W channel 21 measures SAM detection time of each sector and Ds0[i] is calculated therefrom.

Typically, the R/W channel 21 measures each Ds0[i] in plural revolutions the magnetic disk 11. The HDC/MPU 23 obtains Ds0[i] for each revolution and stores each average as Ds0[i]. Data of each Ds0[i] can be saved in a management area on the magnetic disk 11 as control data. It would be possible that the HDC/MPU 23 measures Ts0[i] and Ds0[i] by use of a SAM detection signal from the R/W channel 21.

An initial frequency value of the data clock generation circuit 212 at the time of manufacture is set as f0. The HDC/MPU 23 controls the clock frequency of the clock generation circuit 211 by C_factor according to actual rotational fluctuation of the magnetic disk 11. Therefore, since the initial frequency setting or preset frequency is f0, a newly controlled frequency is represented by

(1+C_factor)*f0 Expression (2)

where C_factor is a positive or negative number near zero.

The HDC/MPU 23 controls this frequency for each servo sector. A frequency corresponding to each servo sector [i] (data area) is represented by f[i]. The HDC/MPU 23 can change the frequency of the data clock generation circuit 212 by setting a data value representing a frequency in a register in the data clock generation circuit 212.

The following describes a case when a jitter in the rotating speed of the magnetic disk 11 is caused by disk shift after shipment of the HDD 1 or a rotational jitter of the SPM 14. When SAM detection time in each servo sector is denoted as Tsm[i] and a time interval between SAM detection timings of servo sectors which are continuously detected is denoted as Dsm[i], Dsm[i] is represented by the following expression:

Dsm[i]=Tsm[i+1]−Tsm[i] Expression (3)

In the following explanation, time measurement of a servo sector is performed based on the clock signal of the servo clock generation circuit 211. The frequency of the servo clock generation circuit 211 is fixed to a constant value. By performing measurement based on the clock signal of the servo clock generation circuit 211 having a certain frequency and controlling the frequency of the data clock generation circuit 212 by means of the technique of the present embodiment, clock frequency control can effectively be performed on a small circuit size.

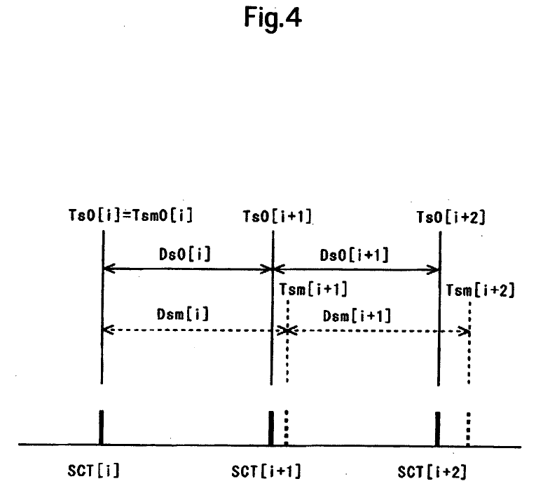

FIG. 4 shows three consecutive servo sectors SCT[i], SCT[i+1], and SCT[i+2]. The solid lines indicate ideal intervals without a rotational jitter of the magnetic disk 11, and the dotted lines indicate intervals with a rotational jitter of the magnetic disk 11. FIG. 4 shows an example where ideal rotation overlaps with shifted rotation at SCT[i] as a starting point of time. Generality of the present embodiment is not lost by the above supposition.

As mentioned above, the following relationship is satisfied in a situation of the ideal rotation.

Ds0[i]=Ts0[i+1]−Ts0[i] Expression (4)

Further, Ds0[i] is preset in the HDD 1 in the manufacturing stage. Then, an expected value of SAM detection time of a servo sector [i] is denoted as Texp[i]. Further, a timing error between the actual SAM detection time Tsm[i] and expected SAM detection time Texp[i] of the servo sector [i] is denoted as Tes[i].

Therefore, the following relationship is satisfied:

Tes[i]=Tsm[i]−Texp[i] Expression (5)

Further, at a SAM detection timing of the servo sector [i], an integral value of Tes[k] in each servo sector which has already been detected is denoted as Sumtes. Therefore, the following relationship is satisfied:

Sumtes[i]=Sumtes[i−1]+Tes[i]=ΣTes[k] Expression (6)

The HDC/MPU 23 expects SAM detection time of a servo sector [i+1] based on the following expression:

Texp[i+1]=Tsm[i]+Ds0[i]−kd*(Tes[i]−Tes[i−1)−kp*Tes[i]−ki*Sumtes[i] Expression (7)

An initial value is given by the following expression without any problem.

Texp[0]=Tsm[0], and Sumtes=0 Expression (8)

The symbols kd, kp, and ki are coefficients for a differential term (Tes[i]−Tes[i−1]), a current term (proportional term) (Tes[i]), and an integral term (Sumtes), respectively. For each of these coefficients, an appropriate value is determined according to the design for each individual product and preset in the HDD 1.

The HDC/MPU 23 determines the frequency control factor C_Factor of the data clock generation circuit 212 so that the following relationship be satisfied.

1+C_Factor[i]=Ds0[i]/(Texp[i+1]−Texp[i]) Expression (9)

Further, the frequency of the data clock generation circuit 212 satisfies a relationship which can be represented by the following expression (10):

f[i]=f0*(1+C_Factor[i]) Expression (10)

Specifically, for writing and reading user data between the servo sector [i] and servo sector [i+1], the clock frequency of the data clock generation circuit 212 is set to f[i] represented by expression (10).

Although each of above-mentioned expressions represents a detection timing of each servo sector by means of the SAM detection time thereof, an expected detection timing can likewise be represented also by the time interval from current servo sector to next adjacent servo sector. Specifically, an expected time interval from the time when the SAM of current servo sector [i] is detected to the time when the SAM of next adjacent servo sector [i+1] is detected is denoted as Dexp[i], and a timing error between an actual measurement time Dsm[i−1] and expected time Dexp[i−1] of each servo sector is denoted as Des[i−1]. Therefore, the following relationship is satisfied.

Des[i−1]=Dsm[i−1]−Dexp[i−1] Expression (11)

Des[i] can be used to determine the frequency of the data clock generation circuit 212 by means of the same technique as the above-mentioned one. Therefore, an expected time Dexp satisfies the following relationship:

Dexp[i]=Dsm[i−1]+(Ds0[i−1]−Ds0[i−2])−kd*(Des[i−1]−Des[i−2])−kp*Des[I−1]−ki*Sumdes[I−1] Expression (12)

Sumdes is defined by the following expression:

Sumdes[i−1]=Sumdes[i−2]+Des[i−1] Expression (13)

Further, an appropriate value of each coefficient is selected in design of the HDD 1.

The frequency control factor C_Factor of the data clock generation circuit 212 and the frequency thereof are determined by the following expressions:

1+C_Factor[i]−Ds0[i]/Dexp[i] Expression (14)

f[i]=f0*(1+C_Factor[i]) Expression (15)

These two techniques having different expressions perform the same operation. Specifically, the HDC/MPU 23 expects a detection timing of each servo sector and specifies an error between the expected value and actual detection timing. The HDC/MPU 23 controls the frequency of the data clock generation circuit 212 based on PID control using a detection timing error of servo sectors which have already been detected.

An example of a specific processing method of the HDC/MPU 23 and R/W channel 21 will be described hereunder. The R/W channel 21 measures a time interval between SAM detection timings, Dsm[i−1], of consecutive servo sectors based on the SAM detection time of each servo sector. The R/W channel 21 measures Dsm[i−1] by use of the clock signal of the servo clock generation circuit 211. The HDC/MPU 23 obtains each Dsm[i−1] from the R/W channel 21.

The HDC/MPU 23 expects a SAM detection timing of each of next adjacent servo sector [i+1] according to expression (12). Specifically, it derives an expected value Dexp[i] of a time interval from detected current servo sector [i] to next adjacent servo sector [i+1]. The HDC/MPU 23 controls the frequency of the data clock generation circuit 212 according to the expected value Dexp[i].

In this manner, the HDC/MPU 23 corrects an expected value of a detection timing of next adjacent servo sector using a sum (multiply-and-accumulation value) of terms which are obtained by multiplying respective coefficients of an integral term, proportional term, and differential term of a difference between an actual detection timing and an expected timing of servo sectors which have already been detected. Specifically, a frequency change factor C_factor[i] is represented as a function calculated from an error between an actual detection timing and expected timing of each servo sector (SAM) (proportional component), a sum of errors that have occurred so far (integral component), and a difference between errors between current servo sector and immediately previous servo sector (differential component).

In this manner, the HDC/MPU 23 changes a clock frequency f[i] in synchronization with the rotation of the magnetic disk 11 by controlling the frequency of the data clock generation circuit 212 according to f0*(1+C_Factor), making it possible to effectively compensate a rotational jitter of the magnetic disk 11.

To realize stable control with a low error rate, it is preferable that clock frequency control be based on the PID control using a difference between an actual detection timing and an expected detection timing of a servo sector, as mentioned above. However, it would be possible to control the clock frequency based on the PI control or integral-term-based control depending on the HDD design. From the viewpoint of the control stability, the PI control is more preferable than the integral-term-based control.

Further, as another preferable technique, it would be possible to control the frequency of the data clock generation circuit 212 by use of a measured detection interval Dsm[i−1] of each sector. Specifically, this technique multiplies the detection intervals between servo sectors which have already been detected by a weighting factor and uses a total sum of these values to control the frequency of the data clock generation circuit 212. The weighting factor is set so that it becomes smaller for more past data. Preferable calculations are represented by the following expression:

$$\begin{matrix}Sum [ i - 1 ] = Dsm [ i - 1 ] + ( 1 / 2 ) * \\ Dsm [ i - 2 ] + ( 1 / 4 ) * Dsm [ i - 3 ] + … \\ = Dsm [ i - 1 ] + ( 1 / 2 ) * sum [ i - 2 ]\end{matrix} \qquad Expression ( 16 )$$

### In this example, all the servo sectors

(1+C_Factor) is represented by the following expression:

1+C_Factor[i−1]=Sum[i−1]/Sum0 Expression (17)

From a time interval Ds0 between servo sectors in ideal rotation, Sum0 is represented by the following expression:

Sum0=Ds0+(½)*Ds0+(¼)*Ds0+ Expression (18)

### In this example, all the servo sectors are assumed equally spaced at an interval of Ds0.

One of advantages of this technique is that the HDC/MPU 23 is not required to hold many of past measurement data since it calculates a frequency correction factor. As shown in expression (16), the HDC/MPU 23 can calculate a frequency correction coefficient from a sum of a value obtained by multiplying Sum[i−1] calculated for immediately previous servo sector by a predetermined coefficient (½ in the above-mentioned example), and a sector interval time Dsm[i−1] identified by the detection of current servo sector. The weighting factor for each term is a positive number less than one. Further, it is preferable that the weighting factor be a power of ½, or addition or subtraction of the powers of ½. This makes it possible to easily calculate Sum through shift operation.

In one aspect, the HDC/MPU 23 can determine whether data can be written or not based on a calculated expected timing. Specifically, when an expected timing or any term representing the expected timing exceeds a predetermined tolerance range, the HDC/MPU 23 stops writing of user data. For example, the HDC/MPU 23 has a reference range with respect to Sumtes or Sumdes. The HDC/MPU 23 compares Sumtes or Sumdes with the reference range and, if Sumtes or Sumdes exceeds the reference range, it stops writing of user data. The HDC/MPU 23 can also perform the similar data write control using Sum.

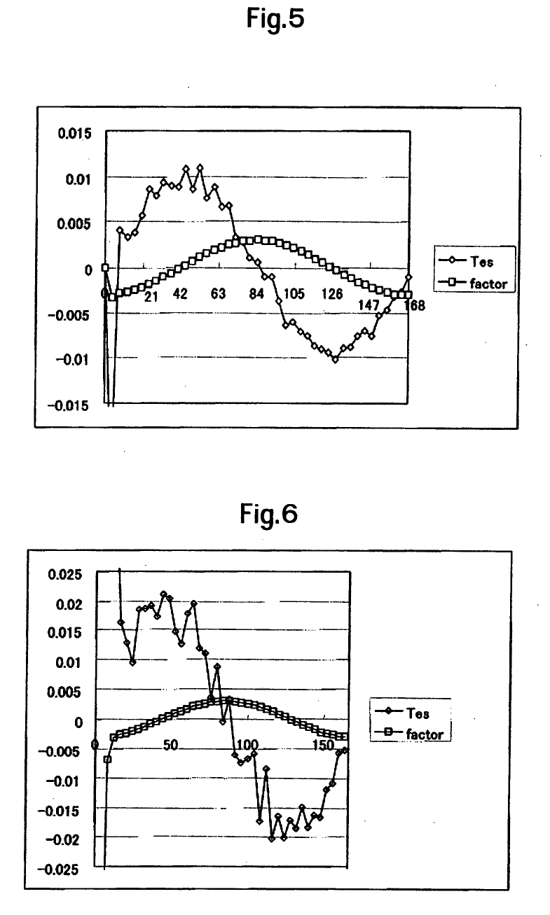

Results of simulation of read/write control of the present embodiment will be described hereunder. FIG. 5 shows a result of simulation of clock frequency control by the PID control (expressions (7) and (9)) of the present embodiment. FIG. 5 shows a result of simulation of frequency correction for a HDD having 4200 rpm rotating speed and 168 sectors, wherein correction is made with kd=0.1, kp=−0.2, and ki=1.0 when there is added a cosine-wave rotational jitter changing at 70 Hz, which is 0.3% of the rotating speed of the magnetic disk, to the rotating speed of the magnetic disk. Further, this calculation takes into consideration a positional variation of each sector, which a condition in which positions of each sector are misaligned up to 5 ns in the positive and negative directions from the positions that are accurately and equally written.

In FIG. 5, the X axis denotes a servo sector position and the Y-axis a detection timing error Tes in μs. The graph shown as Factor represents C_Factor in the above-mentioned expressions (10) and (15), which basically coincide to a cosine wave applied as a rotational jitter. It is understandable that, when clock frequency correction is applied, an error between an actual detection timing and an expected detection timing of each servo sector falls within about 10 ns. Since the time between servo sectors changes by ±255 ns when correction is not applied, it is understandable that correction has a profound effect.

FIG. 6 shows a result of simulation of clock frequency control according to expressions (16) and (17). Design conditions and rotational jitter conditions of the HDD are the same as those in FIG. 5. It is understandable that an error between an actual detection timing and expected detection timing of each servo sector falls within about 20 ns. Although an effect of frequency correction is small as compared with the PID control, it is understandable that the error has become smaller as compared with control without frequency correction.

While the present invention has been described taking a preferred embodiment as an example, the invention is not limited to the above-mentioned embodiment. Persons skilled in the art can easily modify, add, and/or transform the constituent elements of the embodiment within the scope of the invention. For example, embodiments in accordance with the present invention are applicable to disk drive apparatuses using other types of disks, not limited to HDDs.

Although it is preferable that embodiments in accordance with the present invention be applied to reading and writing of user data, there is no restraint to apply the invention only to reading or writing, or to a disk drive apparatus which performs only reading. Further, although it is preferable that a detection timing of each servo sector continuously detected be used, there is no restraint to control the clock frequency for read/write operation using a part of data of servo sectors which have already been detected, as long as the HDD design is allowed.

What is claimed is:

1. A method for writing and/or reading user data on a rotating recording surface having a plurality of servo sectors separately arranged in the circumferential direction and a plurality of data areas in which user data is stored and which are each placed between two adjacent servo sectors of the plurality of servo sectors, the method comprising the steps of:
expecting a detection timing of next adjacent servo sector using a difference between an actual detection timing and an expected detection timing of a servo sector which has already been detected;
adjusting a clock frequency according to the expected detection timing of the next adjacent servo sector; and
writing and/or reading user data between current servo sector and the next adjacent servo sector according to a clock signal having the adjusted frequency.

2. The method according to claim 1, wherein
a detection timing of the next adjacent servo sector is expected using an integral term of a difference between an actual detection timing and an expected detection timing of plural servo sectors which have already been detected.

3. The method according to claim 1, wherein
a detection timing of the next adjacent servo sector is expected using
an integral term of a difference between an actual detection timing and an expected detection timing of plural servo sectors which have already been detected and
a difference term between an actual detection timing and an expected detection timing of the current servo sector.

4. The method according to claim 1, wherein
a detection timing of the next adjacent servo sector is expected using
an integral term of a difference between an actual detection timing and an expected detection timing of plural servo sectors which have already been detected,
a difference term between an actual detection timing and an expected detection timing of the current servo sector, and
a differential term of the difference between the actual detection timing and expected detection timing of the current servo sector, and a difference between an actual detection timing and an expected detection timing of immediately previous servo sector which has been detected.

5. The method according to claim 1, wherein
whether user data can be written is determined based on the expected detection timing.

6. A disk drive apparatus, comprising:
a motor which rotates a disk having a plurality of servo sectors separately arranged in the circumferential direction and a plurality of data areas in which user data is stored and which are each placed between two adjacent servo sectors of the plurality of servo sectors,
a controller which expects a detection timing of next adjacent servo sector using a difference between an actual detection timing and an expected detection timing of a servo sector which has already been detected,
a clock generation circuit which generates a clock signal having a frequency controlled according to the expected detection timing of the next adjacent servo sector, and
a head which writes and/or reads user data between current servo sector and the next adjacent servo sector according to a clock signal having the controlled frequency.

7. The disk drive apparatus according to claim 6, wherein
the controller expects a detection timing of the next adjacent servo sector using
an integral term of a difference between an actual detection timing and an expected detection timing of plural servo sectors which have already been detected.

8. The disk drive apparatus according to claim 6, wherein
the controller expects a detection timing of the next adjacent servo sector using
an integral term of a difference between an actual detection timing and an expected detection timing of plural servo sectors which have already been detected and
a difference term between an actual detection timing and an expected detection timing of the current servo sector.

9. The disk drive apparatus according to claim 6, wherein
the controller controls the clock frequency based on PID control using a difference between an actual detection timing and an expected detection timing of a servo sector which has already been detected.

10. The disk drive apparatus according to claim 6, further comprising:
a fixed clock generation circuit which generates a clock signal having a fixed frequency, wherein
the controller measures a detection timing of each servo sector using the clock signal having the fixed frequency.

11. The disk drive apparatus according to claim 6, wherein
the controller determines whether user data can be written based on the expected detection timing.

12. A disk drive apparatus, comprising:
a motor which rotates a disk having a plurality of servo sectors separately arranged in the circumferential direction and a plurality of data areas in which user data is stored and which are each placed between two adjacent servo sectors of the plurality of servo sectors,
a controller which determines a clock frequency using a multiply-and-accumulation value of detection intervals of servo sectors which have already been detected, the detection intervals being multiplied by a weighting factor that is set so that the weighting factor is smaller for more past data;
a clock generation circuit which generates a clock signal having the determined clock frequency, and
a head which writes and/or reads user data between current servo sector and the next adjacent servo sector according to the clock signal from the clock generator circuit.

13. The disk drive apparatus according to claim 12, wherein
the controller calculates a value by multiplying a multiply-and-accumulation value used to determine a clock frequency in immediately previous servo sector by a predetermined coefficient and
determines the clock frequency using a sum of the detection interval between current servo sector and the immediately previous servo sector, and the calculated value.

14. The disk drive apparatus according to claim 13, wherein
the predetermined coefficient is a positive number less than one.
